(19) United States
(12) Patent Application Publication
(10) Pub. No.: US 2007/0052746 A1
(43) Pub. Date: Mar. 8, 2007

(54) METHOD FOR CONTROLLING AN INK JET PRINTER

(76) Inventor: Hao-Feng Hung, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/469,895

(22) Filed: Sep. 4, 2006

(30) Foreign Application Priority Data
Sep. 5, 2005 (TW) 094130370

(51) Int. Cl. B41J 29/393

(52) U.S. Cl. 347/19

(57) ABSTRACT

The firing frequency of a print head is related to the moving speed of the print head and the printing resolution in the left and right directions. A driving duration is calculated based on the relation of these three parameters. When a nozzle of the print head starts to be heated, a nozzle adjacent to the heated nozzle is heated according to the driving duration.

### BACKGROUND OF THE INVENTION

1. Field of the Invention

The present invention relates to a method for improving printing quality of an ink jet printer, and more particularly, to a method for controlling a print head to jet ink.

2. Description of the Prior Art

Ink jet printers provide good printing quality at a fair price and as a result, have become one of the most popular types of printing equipment. With the quick advancement in technology, better printing quality has become a target that the information industry works to achieve.

Generally, a print head moves in the left and right directions back and forth. When the print head enters a printing region, the print head starts to jet ink onto a print medium. However, when the print head enters the printing region, the speed of the print head has typically not yet been accelerated to a maximum moving speed. In other words, there are constant acceleration motion, constant deceleration motion, and constant speed motion for the print head.

Please refer to FIG. 1, which is a graph of speed of a print head. The speed of the print head must be accelerated to and decelerated from a maximum moving speed Vmax. However, the constant acceleration motion and the constant deceleration motion of the print head take much time. Therefore, in order to take advantage of the acceleration time and the deceleration time, the print head starts to jet ink when the speed of the print head is accelerated to Va (at the time point t1), and stops jetting ink when the speed of the print head is decelerated to Va (at the time point t4). As shown in FIG. 1, the print head jets ink between the time points t1 and t4. However, the speed of the print head is only stable at the speed Vmax between the time points t2 and t3. The speed between the time points t1 and t2 and the speed between the time points t3 and t4 are accelerated and decelerated respectively. This results in different printing quality at different speeds.

A firing frequency of the print head is related to the moving speed of the print head and the printing resolution in the left and right directions on the print medium. The equation is as follows:
V=f/r; equation 1

wherein V (inches per second, ips) represents the moving speed of the print head, f (Hz) represents the firing frequency of the print head, and r (dots per inch, dpi) represents the printing resolution in the left and right directions on the print medium.

Suppose that the printing resolution is 300 dpi and the maximum speed Vmax is 33 ips, according to equation 1, the firing frequency of the print head should be 10 kHz. However, before the speed is accelerated to the maximum speed Vmax, the print head starts to print. Suppose that the print head starts to print when the speed of the print head is accelerated to 16.5 ips. At this time, the firing frequency should be 4.95 kHz, which is different from the firing frequency of 10 KHz of the constant speed motion. Therefore, with the same printing resolution, the firing frequency is different and dependent on the moving speed of the print head.

Please refer to FIG. 2, which is a diagram of nozzles of the print head 10. The print head 10 comprises n nozzles, labeled as C1˜Cn. The print head 10 moves in the left and right directions as the direction of the arrow indicates in FIG. 2. The distance in the left and right directions from the first nozzle C1 to the last nozzle Cn is d (inches).

According to the diagram of nozzles of FIG. 2, the driving pulses for the nozzles Cl˜Cn are shown in FIG. 3. FIG. 3 shows each driving pulse for each nozzle Cl˜Cn. The required nozzle-heating time is t1, and the driving duration of two adjacent nozzles is t2. All nozzles C1˜Cn must be heated within a firing period p of the print head 10, and thereby conform to the required firing frequency.

However, there are constant acceleration motion, constant deceleration motion, and constant speed motion for the print head 10, resulting in different firing frequencies or periods in each condition. The prior art usually uses the same driving duration of two adjacent nozzles in each condition, and this results in the same firing frequency at different moving speeds of the print head which adversely affects printing quality. Therefore, it is important to control the print head to jet ink so as to improve printing uniformity during constant acceleration motion, constant deceleration motion, and constant speed motion.

### SUMMARY OF THE INVENTION

It is therefore a primary objective of the claimed invention to provide a method for controlling an ink jet printer to solve the above-mentioned problem.

The claimed invention discloses a method for controlling an ink-jetting printer. The method comprises calculating a driving duration according to a printing resolution in a first direction on a print medium, a distance in the first direction from a first nozzle of a print head to a last nozzle, a firing period of the print head, and a total number of nozzles of the print head; and after a nozzle of the print head starts to be heated, starting to heat a nozzle adjacent to the heated nozzle according to the driving duration.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a graph of speed of a print head according to the prior art.

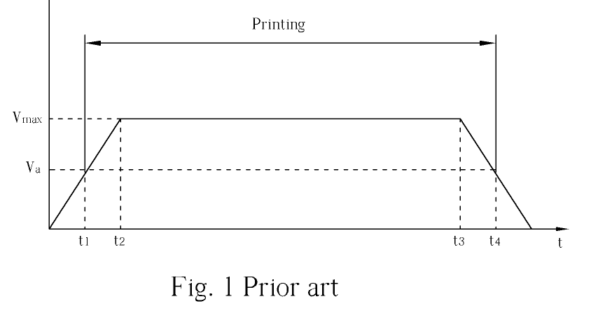

FIG. 2 is a diagram of nozzles of the print head according to the prior art.

FIG. 3 shows each driving pulse for each nozzle according to the prior art.

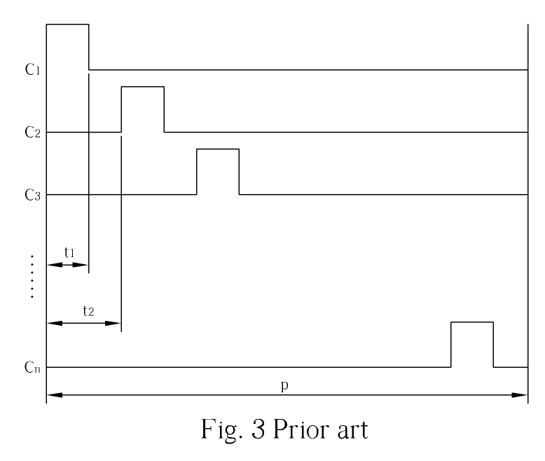

FIG. 4 shows an encoder and an encoder strip inside an ink jet printer according to the present invention.

FIG. 5 is a diagram of a circuit for controlling the ink jet printer according to the present invention.

FIG. 6 shows each signal generated by the circuit of FIG. 5.

### DETAILED DESCRIPTION

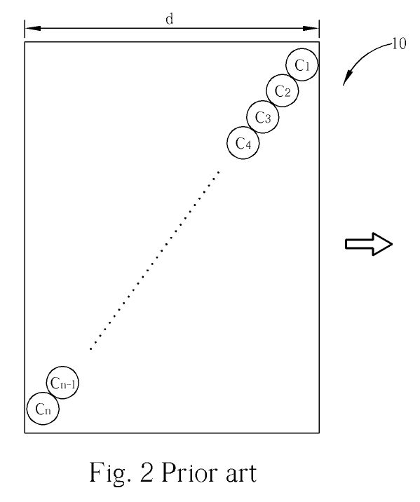

In the first place, the present invention discloses how to calculate the driving duration of adjacent nozzles. Please refer to FIG. 2. The distance in the left and right directions from the first nozzle C1 to the last nozzle Cn is d (inches), and the driving duration t (seconds) is calculated as follows:
t=d/(n*V); equation 2

wherein V is the moving speed (inches per second, ips) of the print head 10, and n is the total number of nozzles of the print head 10.

In fact, the precise driving duration t should be calculated from the following equation:
t=d/[(n−1)*V]; equation 3

There are (n−1) space intervals between the first nozzle C1 and the last nozzle Cn. In order to simplify the calculation and the circuit, the present invention replaces (n−1) of equation 3 with n. The calculation inaccuracy is extremely small.

Next, V of equation 2 is replaced according to equation 1, the converted equation is as follows:
t=d/[n*(f/r)]=(r*d)/(n*f)=(r*d*p)/n; equation 4

wherein f(Hz) is the firing frequency of the print head 10, r (dots per inch, dpi) is the printing resolution in the left and right directions, and p (seconds) is the firing period of the print head 10.

A parameter R=r*d is the product of the printing resolution in the left and right directions and the distance in the left and right directions from the first nozzle to the last nozzle. The parameter R is put into equation 4 as follows:
t=R*p/n; equation 5

wherein the value of R is usually greater than 1 because the printing resolution in the left and right directions is high.

In order to avoid an error that results in a longer or shorter driving duration t, an offset is subtracted from the firing period of the equation 5, so that the equation is as follows:
t=R*(p−offset)/n; equation 6

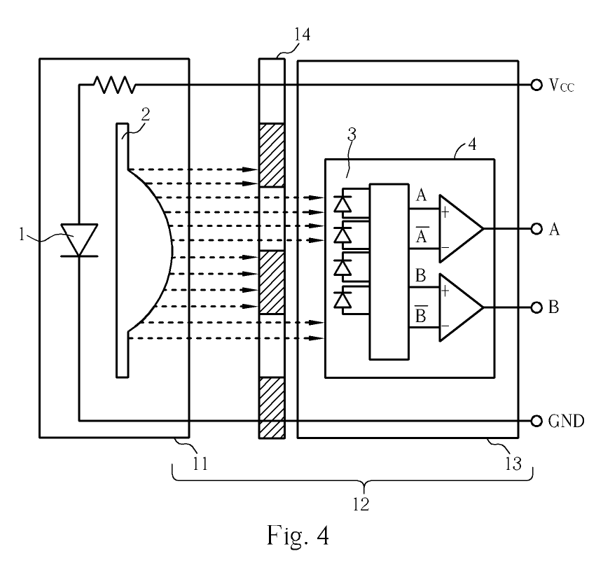

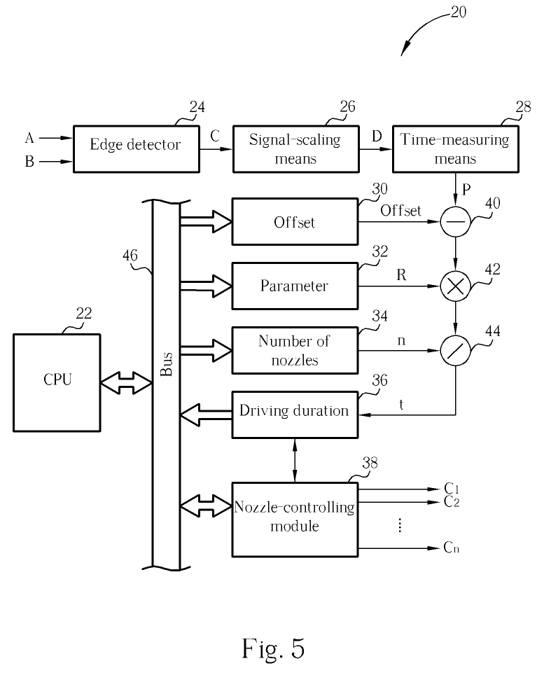

The present invention provides a circuit according to equation 6. Please refer to FIG. 4 and FIG. 5. FIG. 4 shows an encoder 12 and an encoder strip 14 inside the ink jet printer. FIG. 5 is a diagram of a circuit 20 for controlling the ink jet printer according to the present invention. There is an encoder strip 14 having black and white patterns inside the ink jet printer, and an encoder 12 positioned on a printed circuit board in the cartridge of the print head 10. The encoder 12 comprises a light-emitting unit 11 and a light-receiving unit 13. When the encoder 12 scans the encoder strip 14 having black and white patterns, light generated by a light-emitting diode 1 of the light-emitting unit 11 travels through a lens 2, and is projected to the black and white patterns on the encoder strip 14. Light is capable of traveling through the white part of the encoder strip 14 and received by a photo diode 3 of the light-receiving unit 13. Then, light signals are processed by a signal-processing unit 4 to generate two detecting signals A and B having a 90-degree phase difference.

Since the size of black and white patterns is constant, a wavelength of detecting signals A and B is also constant. Suppose that the wavelength of detecting signals A and B is 1/150 inches. That means a cycle of 1/150-inch wavelength is equal to a firing period of 150 dpi. Then, a required signal for the printing resolution is generated via an edge detector 24 and a signal-scaling means 26.

The edge detector 24 receives the detecting signals A and B, and detects a rising edge and a falling edge of the two detecting signals to generate a reference signal C. The cycle of each pulse of the reference signal C is a quarter of the cycle of the detecting signals A and B. The reference signal C is the required signal for 600 dpi.

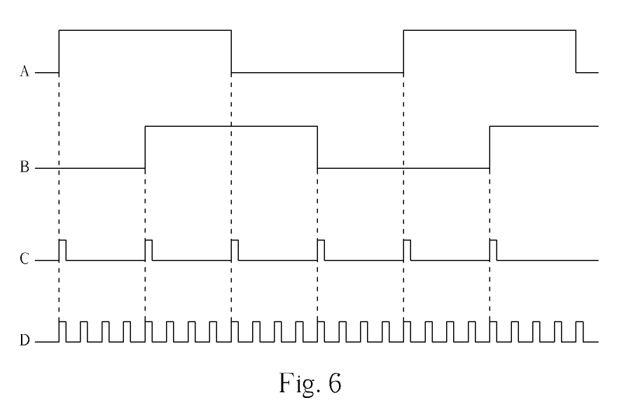

Suppose that the printing resolution is 2400 dpi. Then, the reference signal C is input into the signal-scaling means 26 to adjust the cycle of each pulse of the reference signal C to generate a target signal D. The target signal D is the required signal for 2400 dpi. As mentioned above, all signals are shown in FIG. 6.

Finally, a time-measuring means 28 measures a duration between each pulse of the target signal D to generate a firing period p for 2400 dpi.

Next, the driving duration t of adjacent nozzles is calculated according to equation 6. A central processing unit (CPU) 22 writes values in each register 30˜34 through a bus 46. A first register 30 stores an offset to avoid an error that results in a longer or shorter driving duration t; a second register 32 stores a parameter R; and a third register 34 stores a total number of nozzles n.

The firing period p output from the time-measuring means 28 and the offset in the register 30 are input into a subtractor 40 to obtain a difference (p−offset). Then, a product of the parameter R and the difference, (p−offset)*R, is calculated by a multiplier 42. Eventually, the product is divided by the total number of nozzles n, and an output of a divider 44 is the driving duration t in the equation 6. The driving duration t is stored in a fourth register 36. A nozzle-controlling module 38 controls each nozzle to be heated according to the driving duration t.

No matter whether the moving speed of the print head is accelerated, decelerated, or at a constant speed, the present invention can control driving pulses of each nozzle according to the required firing frequency or period. Therefore, the present invention can improve printing uniformity in constant acceleration motion, constant deceleration motion, and constant speed motion.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling an ink-jetting printer, the method comprising:
calculating a driving duration according to a printing resolution in a first direction on a print medium, a distance in the first direction from a first nozzle of a print head to a last nozzle, a firing period of the print head, and a total number of nozzles of the print head; and
after a nozzle of the print head starts to be heated, starting to heat a nozzle adjacent to the heated nozzle according to the driving duration.

2. The method of claim 1 further comprising:
generating two detecting signals having a 90-degree phase difference;
generating a reference signal according to the two detecting signals;
generating a target signal by adjusting a frequency of the reference signal; and
generating the firing period of the print head according to the target signal.

3. The method of claim 2, wherein generating the two detecting signals with 90-degree phase difference comprises scanning an encoder strip.

4. The method of claim 2, wherein generating the reference signal comprises detecting a rising edge and a falling edge of each detecting signal.

5. The method of claim 2, wherein generating the target signal comprises adjusting the frequency of the reference signal according to the printing resolution in the first direction on the print medium.

6. The method of claim 2, wherein generating the firing period of the print head comprises measuring a duration between each pulse of the target signal.

7. A circuit for controlling a nozzle to jet ink, the circuit comprising:
an edge detector for detecting a rising edge and a falling edge of two detecting signals having a 90-degree phase difference to generate a reference signal;
a signal-scaling means coupled to the edge detector for generating a target signal according to a printing resolution in a first direction on a print medium and the reference signal;
a time-measuring means coupled to the signal-scaling means for measuring a duration between each pulse of the target signal to generate a firing period;
a first register for storing a offset;
a subtractor coupled to the time-measuring means and the first register for subtracting the offset stored in the first register from the firing period output from the time-measuring means and;
a second register for storing a parameter derived from a product of the printing resolution in the first direction on the print medium and a distance from a first nozzle of a print head to a last nozzle in the first direction;
a multiplier coupled to the subtractor and the second register for performing a multiplication of the parameter stored in the second register and an output of the subtractor;
a third register for storing a total number of nozzles;
a divider coupled to the multiplier and the third register for dividing an output of the multiplier by the number of nozzles stored in the third register to generate a driving duration;
a fourth register coupled to the divider for storing the driving duration; and
a nozzle-controlling module coupled to the fourth register, wherein after a nozzle of the print head starts to be heated, the nozzle-controlling module starts to heat a nozzle adjacent to the heated nozzle according to the driving duration.

8. The circuit of claim 7 further comprising:
a bus coupled to each register and the nozzle-controlling module; and
a central processing unit coupled to the bus for transmitting data to each register and the nozzle-controlling module via the bus.
